(19) United States
(12) Patent Application Publication
(10) Pub. No.: US 2026/0356326 A1
(43) Pub. Date: Nov. 12, 2026

(54) ADAPTER FOR WINDSCREEN WIPER BLADE, WINDSCREEN WIPER AND VEHICLE

(71) Applicant: VALEO SYSTEMES D'ESSUYAGE, La Verriere (FR)

(72) Inventors: Vincent GAUCHER, La Verriere (FR); Jerome JEANPIERRE, La Verriere (FR); Philippe BILLOT, La Verriere (FR)

(73) Assignee: VALEO SYSTEMES D'ESSUYAGE, La Verriere (FR)

(21) Appl. No.: 19/134,831

(22) PCT Filed: Dec. 11, 2023
(86) PCT No.: PCT/EP2023/085202

§ 371 Date: Jun. 2, 2025

(30) Foreign Application Priority Data
Dec. 14, 2022 (FR) FR2213402

(51) Int. Cl. B60S 1/04; B60S 1/40

(52) U.S. Cl. CPC B60S 1/0408; B60S 1/4087

(57) ABSTRACT

The invention proposes a windshield wiper blade adapter configured to assemble a windshield wiper blade to a windshield wiper arm. The adapter extends in a longitudinal direction between a first longitudinal end and a second longitudinal end, the first longitudinal end being configured to receive the arm. The adapter includes an airflow leading surface that extends from the first longitudinal end to the second longitudinal end in a divergent manner. The invention also relates to a windshield wiper with the adapter and to a vehicle with the windshield wiper. The invention makes it possible to improve the wiping quality.

### TECHNICAL FIELD

The invention relates to a windshield wiper blade adapter, to a windshield wiper with the adapter and to a vehicle with the windshield wiper.

### BACKGROUND OF THE INVENTION

The aerodynamic performance of the connections between the windshield wiper arm and the windshield wiper blade does not allow the blade to be applied sufficiently against the window to be wiped. As a result, the window wiping quality is not sufficient.

There is therefore a need for a connection between the windshield wiper arm and the windshield wiper blade that enables the wiping quality to be improved.

### SUMMARY OF THE INVENTION

The aim of the invention is to provide a connection between the windshield wiper arm and the windshield wiper blade that enables the wiping quality to be improved.

To this end, the invention proposes a windshield wiper blade adapter configured to assemble a windshield wiper blade to a windshield wiper arm, the adapter extending in a longitudinal direction between a first longitudinal end and a second longitudinal end, the first longitudinal end being configured to receive the arm, the adapter further comprising an airflow leading surface that extends from the first longitudinal end to the second longitudinal end in a divergent manner.

According to one variant, the airflow leading surface diverges at an angle of greater than 0° and of less than or equal to 35° with respect to the longitudinal direction.

According to one variant, the adapter further comprises an airflow trailing surface that extends from the first longitudinal end to the second longitudinal end of the adapter, parallel to the longitudinal direction.

According to one variant, the adapter further comprises an upper wall delimited transversely to the longitudinal direction by the airflow leading surface and by the airflow trailing surface, a side wall joined to the upper wall by the airflow trailing surface, the upper wall and the side wall delimiting an internal volume in which an arm receiving housing, which is accessible via the first longitudinal end, is arranged.

According to one variant, the internal volume further comprises a cavity for attaching a blade connector.

According to one variant, the upper wall comprises a planar segment joined to the airflow leading surface and to the airflow trailing surface by curved segments.

According to one variant, the second longitudinal end flares out from the airflow leading surface toward the air trailing surface, such that the airflow leading surface is longitudinally shorter than the airflow trailing surface toward the second end.

According to one variant, the first longitudinal end flares out from the airflow leading surface toward the airflow trailing surface, such that the airflow leading surface is longitudinally shorter than the airflow trailing surface toward the first end.

The invention also relates to a windshield wiper comprising a windshield wiper arm, a windshield wiper blade and the adapter as described above, the adapter joining an end of the windshield wiper arm to the windshield wiper blade.

The invention also relates to a vehicle comprising the windshield wiper as described above, wherein the airflow leading surface of the adapter faces the front of the vehicle when the windshield wiper is in the rest position.

All of the preferred embodiments and all of the advantages of the adapter according to the invention may be transferred, mutatis mutandis, to the present windshield wiper and to the vehicle, and vice versa. The different embodiments can be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 shows a view of a windshield wiper;

FIG. 2 shows a front view of a vehicle;

FIG. 3 shows a top view of the adapter of the windshield wiper according to FIG. 1; and

FIG. 4 shows a profile view of the adapter of the windshield wiper according to FIG. 1.

The drawings in the figures are not to scale. Similar elements are generally denoted by similar reference signs in the figures. In the context of this document, identical or similar elements can bear the same reference signs. Furthermore, the presence of reference numbers or letters in the drawings cannot be considered limiting, including when these numbers or letters are indicated in the claims.

### DETAILED DESCRIPTION OF THE INVENTION

The invention proposes a windshield wiper blade adapter, which is configured to assemble a windshield wiper blade to a windshield wiper arm. The adapter extends in a longitudinal direction between a first longitudinal end and a second longitudinal end, the first longitudinal end being configured to receive the arm. The adapter further comprises an airflow leading surface that extends from the first longitudinal end to the second longitudinal end in a divergent manner. Such a shape of the airflow leading surface makes it possible to use the airflow generated by a moving vehicle to apply pressure to the adapter and therefore to the blade of the windshield wiper. The connection between the windshield wiper arm and the windshield wiper blade makes it possible to better apply the blade to the window to be wiped and thus to improve the wiping quality.

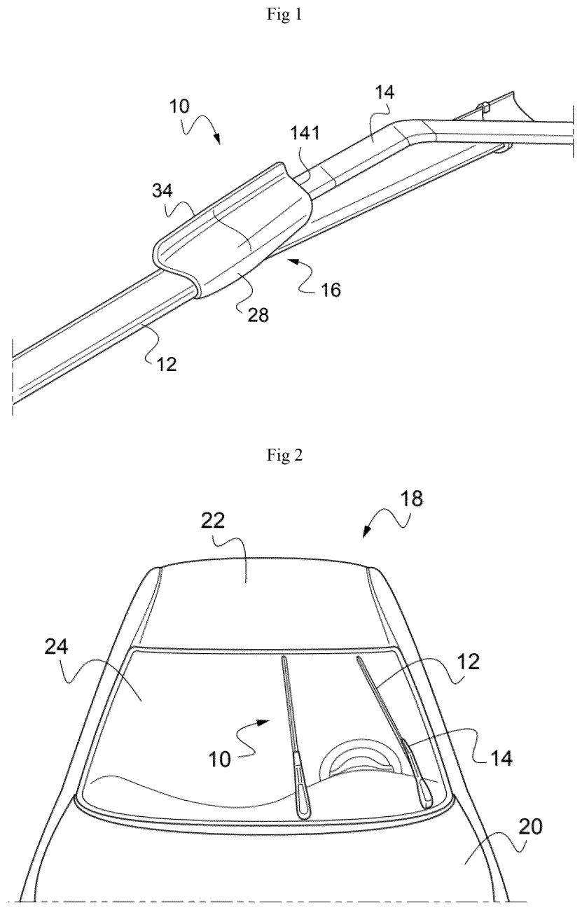

FIG. 1 is a view of a windshield wiper 10. The windshield wiper 10 comprises a windshield wiper blade 12 and a windshield wiper arm 14. The windshield wiper 10 further comprises an adapter 16 for assembling or connecting the blade 12 to the arm 14.

The blade 12 may have an elongate shape. The blade 12 may have a longitudinal shape. In other words again, the blade 12 may extend in a longitudinal direction. The blade 12 may comprise one or more splines, which cannot be seen in the figures, and a blade rubber that is able to rest against the window of a vehicle, for example the windshield, and to wipe the latter by means of back-and-forth movements of the windshield wiper 10. The blade 12 is able to exert a pressure in accordance with a defined pattern on the window to be wiped in the longitudinal direction. The pressure on the window is variable along the longitudinal shape of the blade 12, the pressure being greater at the center of the blade—at the adapter in order to compensate for the aerodynamic lift of the adapter.

The arm 14 is driven in movement at one of its ends by drive means and drives the blade 12 in movement at its other end 141. The arm 14 is joined to the blade 12 via a connection comprising the adapter 16. The adapter 16 can be attached to the end 141 of the arm 14 by inserting the end 141 into a housing for receiving the arm within the adapter 16.

FIG. 2 is a front view of a vehicle 18. The vehicle 18 comprises a front hood 20 and a roof 22, as well as a windshield 24 between the hood 20 and the roof 22. The windshield wiper 10 is shown with two blade 12 and arm 14 pairs by way of example. A single blade 12 and arm 14 pair can be envisioned. The windshield wiper 10 moves back and forth so that the blades 12 wipe the windshield. The windshield wiper 10 can move between a rest position, in which the blades 12 and arms 14 are at the bottom of the windshield, substantially along an upper edge of the hood 20 (and transversely to the direction of travel of the vehicle 18), and an end position, in which the blades 12 and arms 14 are straightened (and are substantially in the direction of travel of the vehicle). The position in FIG. 2 is an intermediate position, moving toward the end position. The windshield wiper 10 is shown in FIG. 2 in a position allowing the window portion located in front of the driver to be wiped.

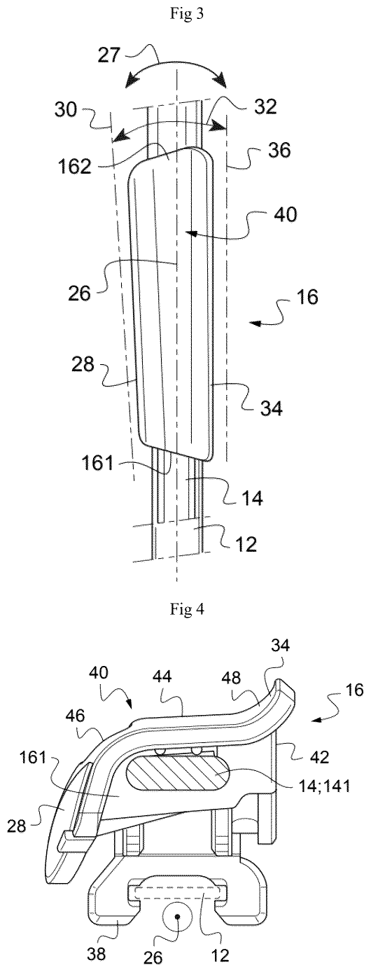

FIG. 3 is a top view of the adapter 16 of the windshield wiper in FIG. 1. The adapter 16 enables the windshield wiper blade 12 to be assembled to the windshield wiper arm 14. The assembly of blade 12, arm 14 and adapter 16 is shown in a vertical position corresponding substantially to the position of the windshield wiper 10 in FIG. 2. The adapter 16 extends in a longitudinal direction 26. The blade 12 also extends substantially in the longitudinal direction 26. The adapter 16 comprises a first longitudinal end 161 and a second longitudinal end 162. The adapter 16 thus extends in the longitudinal direction 26 between the first longitudinal end 161 and the second longitudinal end 162. The first end 161 is configured to receive the arm 14. In other words, the arm 14 is joined to the adapter 16 via the first end 161. The second end 162 is at the opposite end to the first end 161, and therefore at the opposite end to the arm 14. Thus, when the windshield wiper is in the position in FIG. 2, the first end 161 is lower than the second end 162. As the windshield wiper moves, the adapter 16 moves in rotation (this can also be combined with a movement in translation) about an axis corresponding to the axis of rotation of the arm 14—which is located lower than FIG. 3. An arrow 27 shows the movement of the blade 12, the arm 14 and the adapter 16—although the movement can be combined with a movement in translation and the windshield wiper in FIG. 3 is essentially at the end of travel toward the right-hand side, near the end position of the windshield wiper 10.

The adapter further comprises an airflow leading surface 28. The airflow leading surface 28 corresponds to the part or region of the adapter 16 at which the airflow reaches the adapter 16. More specifically, the airflow leading surface 28 corresponds to the part of the adapter 16 that faces the front of the vehicle when the windshield wiper 10 is in the rest position. The airflow leading surface 28 corresponds to the part of the adapter 16 at which the airflow generated by the speed of the vehicle reaches the adapter 16—in particular when the windshield wiper 10 is in the rest position. When the windshield wiper 10 is in the rest position, the airflow generated by the moving vehicle reaches the adapter substantially in a direction transverse to the longitudinal direction 26—substantially perpendicular to the adapter 16 at the leading surface 28. As the windshield wiper 10 moves toward its end position, the blade 12 straightens on the window in such a way that the longitudinal direction 26 of the adapter 16 moves toward the flow axis of the airflow generated by the vehicle on the windshield. As such, the airflow generated by the vehicle reaches the adapter at the first end 161 of the adapter 16.

In order to take better advantage of the pressure of the airflow generated by the vehicle on the adapter 16 during the movement of the windshield wiper 10—and therefore on the blade 12—the airflow leading surface 28 extends from the first longitudinal end 161 to the second longitudinal end 162 in a divergent manner. The leading surface 28 extends from the first longitudinal end 161 to the second longitudinal end 162 in a divergent manner with respect to the longitudinal direction 26 of the adapter 16. In other words, the leading surface 28 flares out between the first end 161 and the second end 162. The leading surface 28 extends along a line 30 that moves away from the longitudinal direction 26, from the first end 161 to the second end 162 of the adapter 16. The leading surface 28 forms a non-zero angle 32 between its extension line 30 and the longitudinal direction 26. The leading surface 28 is not parallel to the longitudinal direction 26 between the first end 161 and the second end 162. When the windshield wiper 10 is in the end position, the leading surface 28 flares out toward the roof 22 of the vehicle. Such a configuration of the adapter 16 makes it possible to take advantage of the pressure that the airflow generated by the vehicle can exert on the adapter 16 even though the windshield wiper is no longer in a position transverse to the airflow generated by the vehicle. Even though the adapter 16 lies across the airflow generated by the vehicle to a lesser extent as the windshield wiper 10 moves toward its end position, the divergence of the leading surface 28 from the first end 161 toward the second end 162 makes it possible to collect pressure of the airflow on the adapter. Incorporating an angle between the leading surface 28 and the longitudinal direction 26 makes it possible to collect pressure on the adapter 16 when the airflow is no longer perpendicular to the blade 12. This makes it possible to continue to apply pressure to the adapter 16 and therefore to the blade 12, thereby improving the wiping of the window when the windshield wiper 10 moves away from its rest position. Incorporating an angle between the leading surface 28 and the longitudinal direction 26 makes it possible to increase the aerodynamic performance of the connection between the arm 14 and the blade 12. The leading surface 28 is thus optimized and better oriented, thereby improving the pressure of the blade on the window.

By way of example, the airflow leading surface 28 diverges at an angle 32 of greater than 0° and of less than or equal to 35° with respect to the longitudinal direction 26 (in the counterclockwise direction from the longitudinal direction 26). Such an angle 32 is a balance between maintaining the pressure as the windshield wiper 10 moves and the size of the adapter 16 (and therefore the bulk of the adapter 16).

The adapter 16 further comprises an airflow trailing surface 34 that extends from the first longitudinal end 161 to the second longitudinal end 162 of the adapter 16, parallel to the longitudinal direction 26. According to FIG. 3, the trailing surface 34 extends along a line 36 parallel to the longitudinal direction 26. The trailing surface 34 corresponds to the part or region of the adapter 16 at which the airflow leaves the adapter 16. More specifically, the airflow trailing surface 34 corresponds to the part of the adapter 16 that faces away from the front of the vehicle (or faces the rear of the vehicle) when the windshield wiper 10 is in the rest position. The airflow trailing surface 34 corresponds to the part of the adapter 16 at which the airflow generated by the speed of the vehicle leaves the adapter 16—in particular when the windshield wiper 10 is in the rest position. When the windshield wiper 10 is in the rest position, the airflow generated by the moving vehicle leaves the adapter substantially in a direction transverse to the longitudinal direction 26—substantially perpendicular to the adapter 16 at the trailing surface 34. As the windshield wiper 10 moves toward its end position, the blade 12 straightens on the window in such a way that the longitudinal direction 26 of the adapter 16 moves toward the flow axis of the airflow generated by the vehicle on the windshield. As such, since the trailing surface 34 is parallel to the longitudinal direction 26, the airflow generated by the vehicle is not disturbed when it flows along the trailing surface 34. This makes it possible to give the adapter an aerodynamic shape and to avoid turbulence at the rear of the adapter 16.

In FIG. 3, the angle 32 is indicated between the lines 30 and 36 in order to indicate that the leading surface 28 is divergent, rather than parallel, with respect to the trailing surface 34. The angle values 32 indicated are between the leading surface 28, which extends along the line 30, and the longitudinal direction 26 or the trailing surface 34, which extends along the line 36 parallel to the longitudinal direction 26.

FIG. 4 is a profile view of the adapter 16 of the windshield wiper according to FIG. 1. FIG. 4 is a view of the end 161 along the direction 26. The adapter 16 is joined to a connector 38 of the blade 12. The arm 14 and the blade 12 are joined by the connection comprising the adapter 16 and the connector 38 attached together. The end 161 of the adapter 16 is configured to receive the arm 14 at its end 141. The airflow leading surface 28 is divergent with respect to the longitudinal direction 26. The trailing surface 34 is parallel to the longitudinal direction 26. The adapter 16 comprises an upper wall 40 delimited transversely to the longitudinal direction 26 by the airflow leading surface 28 and by the airflow trailing surface 34. The adapter 16 also comprises a side wall 42 joined to the upper wall 40 by the airflow trailing surface 34. The upper wall 40 and the side wall 42 delimit a volume internal to the adapter 16 in which an arm 14 receiving housing that is accessible via the first longitudinal end 161 is arranged. The side wall 42 and the upper wall 40 each extend in separate planes. The housing for receiving the arm 14 comprises members for attaching the end 141 of the arm 14 to the adapter 16. In addition, the internal volume comprises a cavity for attaching the connector 38 for the wiping system. The connector 38 is attached to the adapter 16—possibly by an articulation—within the internal volume of the adapter 16. The divergence of the leading edge 28 also makes it possible to have more space in the internal volume for attaching the arm 14 to the adapter 16 and for attaching the connector 38 to the adapter 16.

As can be seen in FIG. 4, the upper wall 40 comprises a planar segment 44 joined to the airflow leading surface 28 and to the airflow trailing surface 34 by curved segments 46 and 48, respectively. This confers an aerodynamic profile on the adapter 16 in such a way that the airflow that is generated by the vehicle and reaches the adapter 16—in particular when the windshield wiper 10 is in the rest position—from the left-hand side in FIG. 4, flows without turbulence along the upper surface 40 toward the right-hand side in FIG. 4. The flow of the airflow applies pressure to the profile of the adapter 16, which is transmitted to the connector 38 and to the blade 12. The airflow reaches the adapter 16 approximately perpendicularly when the windshield wiper leaves its rest position; as the windshield wiper moves toward its end position, the airflow reaches the adapter to a greater extent in the longitudinal direction 26, but the divergence of the leading surface 28 makes it possible to continue to benefit from the pressure of the airflow on the adapter 16.

As can be seen in FIG. 3, the second longitudinal end 162 can flare out from the airflow leading surface 28 toward the air trailing surface 34, such that the airflow leading surface 28 is longitudinally shorter than the airflow trailing surface 34 toward the second end 162. The second end 162 is not perpendicular to the longitudinal direction 26. This makes it possible to improve the aerodynamics of the windshield wiper on the blade 12. This enables the airflow to flow around the second end 162 of the adapter 16 without turbulence—as the windshield wiper moves. In addition, the first longitudinal end 161 can flare out from the airflow leading surface 28 toward the airflow trailing surface 34, such that the airflow leading surface 28 is longitudinally shorter than the airflow trailing surface 34 toward the first end 161. The first end 161 is not perpendicular to the longitudinal direction 26. This also makes it possible to improve the aerodynamics of the windshield wiper on the blade 12. In other words, the leading surface 28 may be shorter than the airflow trailing surface 34 along the longitudinal direction 26, toward the second end 162 and toward the first end 161. The first and second ends 161, 162 converge toward the airflow leading surface 28 (or diverge toward the airflow trailing surface 34). According to a top view, the adapter 16 has a shape that can be compared to a trapezoid, but with the short base (the leading surface 28) inclined with respect to the long base (the trailing surface 34).

The invention also relates to the windshield wiper 10 comprising the windshield wiper arm 14 and the windshield wiper blade 12. The windshield wiper 10 also comprises the adapter 16 joining the end 141 of the arm 14 to the blade 12. The invention also relates to the vehicle 18 comprising the windshield wiper 10. The airflow leading surface 28 of the adapter 16 faces the front of the vehicle when the windshield wiper is in the rest position. The airflow trailing surface 34 of the adapter 16 faces the rear of the vehicle when the windshield wiper is in the rest position. The windshield wiper can move between a plurality of positions as described above. The windshield wiper can move between the rest position and an end position. In the end position, the leading surface 28 diverges in a direction away from the arm 14; the leading surface 28 diverges toward the roof of the vehicle 18. During the movement, the divergence of the airflow leading surface 28 makes it possible to benefit from a pressure exerted by the airflow on the adapter to improve the pressure of the blade against the window of the vehicle. This improves the wiping of the window.

The present invention has been described in relation to specific embodiments, which have purely illustrative value and should not be considered limiting. In general, it will be obvious to a person skilled in the art that the present invention is not limited to the examples illustrated and/or described above.

1. A windshield wiper blade adapter configured to assemble a windshield wiper blade to a windshield wiper arm, the adapter extending in a longitudinal direction between a first longitudinal end and a second longitudinal end, the first longitudinal end being configured to receive the arm, the adapter comprising an airflow leading surface that extends from the first longitudinal end to the second longitudinal end in a divergent manner.

2. The adapter as claimed in claim 1, wherein the airflow leading surface diverges at an angle of greater than 0° and of less than or equal to 35° with respect to the longitudinal direction.

3. The adapter as claimed in claim 1, further comprising an airflow trailing surface that extends from the first longitudinal end to the second longitudinal end of the adapter, parallel to the longitudinal direction.

4. The adapter as claimed in claim 3, further comprising
an upper wall delimited transversely to the longitudinal direction by the airflow leading surface and by the airflow trailing surface,
a side wall joined to the upper wall by the airflow trailing surface,
the upper wall and the side wall delimiting an internal volume in which an arm receiving housing, which is accessible via the first longitudinal end, is arranged.

5. The adapter as claimed in claim 4, wherein the internal volume includes a cavity for attaching a blade connector.

6. The adapter as claimed in claim 4, wherein the upper wall includes a planar segment joined to the airflow leading surface and to the airflow trailing surface by curved segments.

7. The adapter as claimed in claim 3, wherein the second longitudinal end flares out from the airflow leading surface toward the air trailing surface, such that the airflow leading surface is longitudinally shorter than the airflow trailing surface toward the second end.

8. The adapter as claimed in claim 3, wherein the first longitudinal end flares out from the airflow leading surface toward the airflow trailing surface, such that the airflow leading surface is longitudinally shorter than the airflow trailing surface toward the first end.

9. A windshield wiper comprising a windshield arm, a windshield wiper blade and an adapter, the adapter joining an end of the windshield wiper arm to the windshield wiper blade, with the adapter extending in a longitudinal direction between a first longitudinal end and a second longitudinal end, the first longitudinal end being configured to receive the windshield wiper arm, the adapter comprising an airflow leading surface that extends from the first longitudinal end to the second longitudinal end in a divergent manner.

10. A vehicle comprising a windshield wiper, wherein the windshield wiper includes a windshield arm, a windshield wiper blade and an adapter, the adapter joining an end of the windshield wiper arm to the windshield wiper blade, with the adapter extending in a longitudinal direction between a first longitudinal end and a second longitudinal end, the first longitudinal end being configured to receive the windshield wiper arm, the adapter comprising an airflow leading surface that extends from the first longitudinal end to the second longitudinal end in a divergent manner, and the airflow leading surface of the adapter faces the front of the vehicle when the windshield wiper is in the rest position
